(19) United States
(12) Patent Application Publication
(10) Pub. No.: US 2025/0342980 A1
(43) Pub. Date: Nov. 6, 2025

(54) FLOOD ILLUMINATION WITH INTEGRATED CONCENTRATORS FOR HIGH-EXTINCTION BEAM DELIVERY

(71) Applicant: Quantinuum LLC, Broomfield, CO (US)

(72) Inventors: Adam Jay OLLANIK, Boulder, CO (US); James HOSTETTER, Eagan, MN (US); Rezlind BUSHATI, Broomfield, CO (US); David M. GAUDIOSI, Loveland, CO (US); Mary A. ROWE, Boulder, CO (US); Matthew J. BOHN, Broomfield, CO (US); Justin Thomas SCHULTZ, Westminster, CO (US)

(21) Appl. No.: 19/172,019

(22) Filed: Apr. 7, 2025

Related U.S. Application Data
(60) Provisional application No. 63/642,272, filed on May 3, 2024.

(51) Int. Cl. G21K 1/00; B82Y 10/00; G02B 27/18; G06N 10/40; G21K 1/02; G21K 1/04

(52) U.S. Cl. CPC G21K 1/003; B82Y 10/00; G02B 27/18; G06N 10/40; G21K 1/025; G21K 1/043

(57) ABSTRACT

A system is provided that includes a confinement apparatus configured to confine a plurality of quantum objects within one or more confinement regions; and one or more optical concentrators. Each optical concentrator of the one or more optical concentrators is configured to concentrate optical power incident thereon into a respective focal region. The respective focal region has a non-zero spatial overlap area with at least one of the one or more confinement regions. The focal region has an area that is smaller than a surface area of the optical concentrator.

### CROSS-REFERENCE TO RELATED APPLICATION(S)

This application claims priority to U.S. Application No. 63/642,272, filed May 3, 2024, the content of which is incorporated herein by reference in its entirety.

### TECHNICAL FIELD

Various embodiments relate to delivery of optical beams to target locations of a confinement apparatus for particle interaction. For example, various embodiments relate to the use of flood illumination of at least a portion of an assembly including the confinement apparatus and optical concentrators to provide optical beams to target locations of the confinement apparatus.

### BACKGROUND

In various systems, the evolution of the quantum state of an ion is controlled by applying laser beams to the ions. When the system includes multiple ions, it is important to be able to control which ions are and which ions are not illuminated by various laser beams. Generally, this is accomplished through the use of pencil beams (e.g., laser beams with a small cross-sectional area) such that each laser beam only illuminates a small portion of the system. However, minor misalignment of the pencil beams with the ion locations may result in the optical power delivered to a target ion being insufficient for the quantum state evolution to be performed, the target ion being missed by the laser beam, and/or other ions being unintentionally affected by the laser beam. Through applied effort, ingenuity, and innovation many deficiencies of such systems have been solved by developing solutions that are structured in accordance with the embodiments of the present invention, many examples of which are described in detail herein.

### BRIEF SUMMARY OF EXAMPLE EMBODIMENTS

Example embodiments provide confinement apparatuses, systems comprising confinement apparatuses, controllers configured for controlling components of a system comprising a confinement apparatus, and/or the like. In various embodiments, the system includes a confinement apparatus that defines one or more confinement regions and one or more optical concentrators configured to concentrate optical power incident thereon into respective one or more focal regions. Each focal region overlaps with at least one confinement region such that each focal region has a non-zero spatial overlap area with at least one confinement region. A spatial overlap area has a geometric area that is smaller (e.g., in surface area) than the surface area of the corresponding optical concentrator. Thus, the intensity of the optical power provided to the focal region (e.g., the spatial overlap area) by the optical concentrator is greater than the intensity of an optical signal that provided the optical power to the optical concentrator.

In various embodiments, the confinement apparatus comprises a plurality of electrodes formed on a first substrate. In some embodiments, at least one of the one or more optical concentrators are formed and/or disposed on and/or in (referred to herein as on) the first substrate. In some embodiments, a second substrate is secured with respect to the first substrate and at least one of the one or more optical concentrators are formed and/or disposed on the second substrate.

In various embodiments, the optical signal may be configured to illuminate a selected portion of an assembly including the confinement apparatus. For example, in various embodiments, the system may include a beam path system configured to delivery an optical signal generated by a manipulation source (e.g., laser) to a selected portion of the assembly including the confinement apparatus. In an example embodiment, the beam path system comprises a plurality of sets of projection optics that are each configured to illuminate a respective portion of the assembly including the confinement apparatus. For example, the beam path system may include a component (e.g., an electro-optical deflector and/or the like) configured to provide an optical signal to a selected set of projection optics to cause the selected portion of the assembly including the confinement apparatus to be illuminated by the optical signal.

According to one aspect, a system is provided. The system includes a confinement apparatus configured to confine a plurality of quantum objects within one or more confinement regions; and one or more optical concentrators. Each optical concentrator of the one or more optical concentrators is configured to concentrate optical power incident thereon into a respective focal region. The respective focal region has a non-zero spatial overlap area with at least one of the one or more confinement regions. The focal region has an area that is smaller than a surface area of the optical concentrator.

In an example embodiment, the confinement apparatus is formed on a first substrate and at least one of the one or more optical concentrators is disposed on the first substrate.

In an example embodiment, the confinement apparatus is formed on a first substrate and the system further comprises a second substrate that is secured with respect to the first substrate and at least one of the one or more optical concentrators is disposed on the second substrate.

In an example embodiment, at least one of the one or more optical concentrators is configured to filter optical power incident thereon based on at least one optical property of an optical signal carrying the optical power such that responsive to the optical signal being characterized by a target optical property, the optical power provided by the optical signal is concentrated to the respective focal region, and responsive to the optical signal not being characterized by the target optical property, the optical power provided by the optical signal is not concentrated to the respective focal region.

In an example embodiment, the target optical property is a wavelength, a wavelength range, an angle of incidence, an angle of incidence range, a polarization, an optical mode, or combination of two or more thereof.

In an example embodiment, the at least one of the one or more optical concentrators is configured to have multiple optical signals incident thereon, possibly simultaneously, and to perform filtering of the multiple optical signals based on the least one optical property of respective optical signals of the multiple optical signals.

In an example embodiment, the confinement apparatus is formed on a first substrate, the system further comprises a second substrate that is secured with respect to the first substrate, the at least one of the one or more optical concentrators that is configured to filter optical power incident thereon based on the at least one optical property of the optical signal carrying the optical power comprises two or more optical concentrators that are disposed on the second substrate in a layered fashion.

In an example embodiment, the optical concentrator is configured to control at least one optical property of the concentrated optical power at the respective focal region.

In an example embodiment, the optical concentrator is configured to control the at least one optical property of the concentrated optical power at the respective focal region such that the at least one optical property of the concentrated optical power is different from a corresponding optical property of the optical power incident on the optical concentrator.

In an example embodiment, the at least one optical property of the concentrated optical power is configured to cause the concentrated optical power to interact more strongly with one or more quantum and/or atomic objects disposed at the respective focal region compared to the corresponding optical property of the optical power incident on the optical concentrator.

In an example embodiment, the non-zero spatial overlap area extends along at least a portion of a length of a confinement region of the one or more confinement regions.

In an example embodiment, the concentrated optical power at the respective focal region is configured to control evolution of a quantum state of one or more quantum objects disposed at the focal region.

In an example embodiment, the evolution of the quantum state of the one or more quantum objects disposed at the focal region includes performance of one or more of a single qubit gate, a two-qubit gate, a cooling operation, a repumping operation, a shelving operation, a state preparation operation, or a reading operation.

In an example embodiment, the confinement apparatus is formed on a first substrate and the system further comprises a second substrate that is secured with respect to the first substrate and at least one of the one or more optical concentrators is disposed on the second substrate, wherein one or more extinction elements are disposed on the second substrate and the one or more extinction elements are configured to reduce an amount of optical power provided to the one or more confinement regions via portions of the second substrate that are not associated with the one or more optical concentrators.

In an example embodiment, the confinement apparatus is formed on a first substrate and the system further comprises a second substrate that is secured with respect to the first substrate, the one or more optical concentrators comprises a plurality of optical concentrators disposed on the second substrate, and adjacent optical concentrators of the plurality of optical concentrators are configured to have shared boundaries therebetween.

In an example embodiment, the system further includes an optical path system configured to cause an optical signal to be incident on at least a portion of a selected at least one of the one or more optical concentrators.

In an example embodiment, the optical path system comprises a switchable component and two or more sets of projection optics, operation of the switchable component causes an optical signal to be provided to a selected set of projection optics of the two or more sets of projection optics, and the selected set of projection optics are configured to project the optical signal with a projection pattern that illuminates the selected at least one of the one or more optical connectors.

In an example embodiment, the switchable component is an electro-optic deflector.

In an example embodiment, the optical path system is configured to use at least one of spatial light modulation, beam forming, higher-order optical modes, holograms, or time-multiplexing to cause the optical signal to be incident on the selected at least one of the one or more optical concentrators.

In an example embodiment, spatial light modulation is used to adjust an intensity distribution of the optical signal in a way that optimizes operation of a desired optical/ion interaction across all target regions being illuminated.

In an example embodiment, the optical power concentrated is concentrated by a factor of at least 1000 compared to the optical power incident on the optical concentrator.

In an example embodiment, the confinement apparatus is formed on a first substrate, the system further comprises a second substrate that is secured with respect to the first substrate, a first concentrator of the one or more optical concentrators is disposed on the second substrate, an annular portion of the first substrate defined by the projection of the first concentrator minus the respective focal region corresponding to the first concentrator is a shadow region and less optical power is incident thereon compared to an area just outside the shadow region.

According to another aspect, a system is provided. The system includes a confinement apparatus configured to confine a plurality of quantum objects in one or more confinement regions; and a beam path system comprising a switchable component and two or more sets of projection optics. Each of the two or more sets of projection optics are configured to, when an optical signal is incident thereon, illuminate a respective portion of the confinement apparatus. Operation of the switchable component is configured to select on which of the two or more sets of projection optics the optical signal is incident.

In an example embodiment, the system further includes at least one manipulation source configured to generate the optical signal; and a controller configured to control operation of the manipulation source and the switchable component.

In an example embodiment, the controller is configured to select a set of projection optics and to control operation of the switchable component such that the optical signal is provided to the selected set of projection optics.

In an example embodiment, the switchable component is an electro-optic deflector.

In an example embodiment, the system further includes one or more optical concentrators, wherein each optical concentrator of the one or more optical concentrators is configured to concentrate optical power incident thereon into a respective focal region, the respective focal region has a non-zero spatial overlap area with at least one of the one or more confinement regions, and the focal region has an area that is smaller than a surface area of the optical concentrator.

In an example embodiment, the two or more sets of projection optics are configured to control a structure of the optical signal.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example system comprising an assembly including a confinement apparatus, in accordance with an example embodiment.

FIG. 2 provides a top view of at least a portion of an example assembly including a confinement apparatus, in accordance with an example embodiment.

FIG. 3 provides a cross-sectional view of at least a portion of the example assembly including the confinement apparatus shown in FIG. 2.

FIGS. 4A & 4B provide cross-sectional views of at least a portion of other example assemblies including a confinement apparatus, in accordance with an example embodiment.

FIG. 5 provides a cross-sectional view of a portion of an assembly including a confinement apparatus, in accordance with an example embodiment.

FIGS. 6A and 6B illustrate two different illumination scenarios of an example assembly including a confinement apparatus in cross-sectional view, in accordance with various embodiments.

FIGS. 7A and 7B illustrate two different illumination scenarios of an example assembly including a confinement apparatus in cross-sectional view, in accordance with an example embodiment.

FIG. 8 provides a top view of an example confinement region and optical concentrators configured to concentrate optical power into a focal region that extends along the confinement region, in accordance with an example embodiment.

FIG. 9 provides a top view of an example confinement apparatus and a plurality of optical concentrators configured to concentrate optical power into respective focal regions, where the respective focal regions overlap with a target region defined by the confinement apparatus, in accordance with an example embodiment.

FIGS. 10A and 10B illustrate example confinement regions of a confinement apparatus and example portions that may be illuminated via respective sets of projection optics, in accordance with an example embodiment.

FIGS. 11A, 11B, and 11C provide schematic block diagrams of an example beam path system configured to illuminate a selected portion of an assembly including a confinement apparatus by providing an optical signal to a selected set of projection optics, in accordance with an example embodiment.

FIG. 12 provides a flowchart illustrating various processes, procedures, operations, and/or the like performed by a controller of FIG. 13, for example, to cause illumination of a selected portion of the assembly including the confinement apparatus, in accordance with an example embodiment.

FIG. 13 provides a schematic diagram of an example controller of a system comprising a confinement apparatus configured for confining atomic objects therein, in accordance with an example embodiment.

FIG. 14 provides a schematic diagram of an example computing entity of a system comprising a confinement apparatus that may be used in accordance with an example embodiment.

### DETAILED DESCRIPTION OF SOME EXAMPLE EMBODIMENTS

The present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

In various scenarios, quantum objects are confined by a confinement apparatus and the quantum state of the quantum objects are manipulated and/or caused to undergo a controlled quantum state evolution. For example, the quantum state of the quantum objects may be manipulated to perform experiments, controlled quantum state evolution, quantum computations, and/or the like. For example, the confinement apparatus may be part of a quantum and/or atomic system, such as an atomic clock, spectroscopic and/or mass analyzer system, a quantum computer such as quantum charge-coupled device (QCCD)-based quantum computer, and/or the like. In various embodiments, a quantum object is an ion; atom; ionic, neutral, and/or multipolar molecule; quantum dot; quantum particle; group, crystal, and/or combination thereof (e.g., an ion crystal comprising two or more ions); and/or the like. In an example embodiment where the quantum objects are ions and/or ion crystals, the confinement apparatus is an ion trap, such as a surface ion trap, Paul ion trap, and/or the like. In various other embodiments, the confinement apparatus is an apparatus configured to confine quantum objects and comprises a plurality of surface electrodes. For example, in various embodiments, the confinement apparatus comprises a plurality of surface electrodes formed on a first substrate. In various embodiments, the confinement apparatus may include various potential generating elements configured to generate a confining potential for confining quantum objects. For example, the surface electrodes and/or other potential generating elements are configured to (when an appropriate control signal is applied thereto) generate one or more confinement regions within which the quantum objects are confined.

In various embodiments, an assembly including the confinement apparatus is illuminated with a low intensity optical signal (e.g., an optical signal having an intensity that is too low to perform a quantum state evolution). The assembly also includes one or more optical concentrators. In various embodiments, one or more optical concentrators are formed and/or disposed on the first substrate (e.g., a substate housing potential generating elements of the confinement apparatus). In various embodiments, the assembly including the confinement apparatus includes a second substrate that is secured with respect to the first substrate. In such embodiments, one or more optical concentrators may be formed and/or disposed on and/or in the second substrate.

The optical concentrators are configured to concentrate optical power incident thereon, into respective focal regions. In various embodiments, the focal regions overlap with respective confinement regions and/or portions thereof. For example, an optical concentrator is configured to concentrate the low intensity light into a focal region that spatially overlaps with a confinement region. This causes the focal region, and any quantum objects disposed within the portion of the confinement region that overlaps with the focal region, to experience a high intensity optical signal (e.g., an optical signal having an intensity that is high enough to perform the quantum state evolution). For example, the area of the focal region (e.g., the area of the spatial overlap between the focal region and the confinement region) taken in a plane that is parallel to a surface of the confinement apparatus (e.g., a surface of the first substrate) is smaller than the surface area of the optical concentrator(s) configured to concentrate optical signals into the focal region.

The high intensity optical signal experienced by quantum objects confined within the confinement region where the focal region overlaps the confinement region may cause a controlled quantum state evolution of the quantum objects. For example, the optical signal may be configured to perform, at least in part, a single qubit gate, a two or more-qubit gate, an initialization operation, a qubit reading operation, a laser cooling operation, a shelving operation, and/or the like.

Conventional techniques for providing laser beams to ions, for example, trapped by an ion trap, include focusing pencil beams on select ion locations. For example, when the system includes multiple ions, it is important to be able to control which ions are and which ions are not illuminated by various laser beams. The pencil beams have a small cross-sectional area such that each laser beam only illuminates a small portion of the system. However, minor misalignment of the pencil beams with the ion locations may result in the optical power delivered to a target ion being insufficient for the desired quantum state evolution to be performed, the target ion being missed by the laser beam, and/or other ions being unintentionally affected by the laser beam. As the cross-sectional area of the pencil beams is quite small, aligning the pencil beams and maintaining alignment throughout the performance of an experiment and/or a quantum circuit can be challenging. Thus, technical problems exist regarding how to efficiently and robustly provide optical signals to select locations of a confinement apparatus while not causing cross-talk errors by causing unintended interactions at other locations of the confinement apparatus.

Various embodiments provide technical solutions to these technical problems. For example, in various embodiments, at least a portion of an assembly including the confinement apparatus is illuminated with a low intensity optical signal. One or more optical concentrators of the assembly concentrate optical power incident thereon to cause a high intensity optical signal to be provided to a focal region. The focal region overlaps with a confinement region such that quantum objects confined within the spatial overlap of the confinement region and the focal region experience the high intensity optical signal and therefore experience the corresponding quantum state evolution. In various embodiments, the low intensity optical signal has an intensity (e.g., optical power per area) that is too low to perform a corresponding quantum state evolution. For example, when at least a portion of the assembly is illuminated with a low intensity optical signal, the extinction between a focal region and a portion of the confinement apparatus that is outside of the focal region may be −30 dB or more. In some embodiments, the optical concentrators are configured and/or extinction elements are included in the assembly such that the extinction between focal regions and areas of the confinement region outside of focal regions is more than −30 dB. Thus, quantum objects located outside of the focal region may generally not be affected by the low intensity optical signal.

As the optical concentrators are formed on a first substrate hosting the potential generating elements of the confinement apparatus and/or on a second substrate that is secured with respect to the first substrate, the alignment of the optical concentrators and the corresponding focal regions to the confinement region(s) is stable and independent of the projection optics configured to provide the low intensity optical signal. The system is therefore not sensitive to small changes in alignment of the projection optics providing the low intensity optical signal to the assembly.

Therefore, various embodiments provide technical improvements to the fields of beam delivery to trapped particles, atomic and/or quantum systems that use optical signals to interact with trapped particles, and quantum computing.

### Exemplary System Comprising a Confinement Apparatus

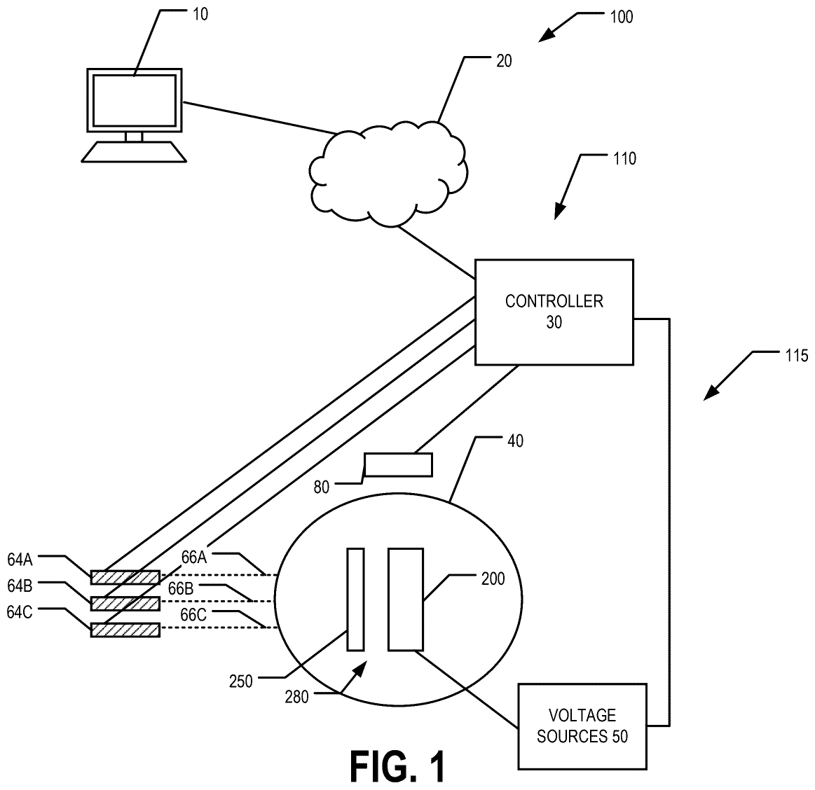

As noted above, various confinement apparatuses and various assemblies including confinement apparatuses may be incorporated into various atomic systems, quantum systems, and/or the like. For example, various embodiments provide a system 100 comprising an assembly 280 that includes a confinement apparatus 200, as shown in FIG. 1. The confinement apparatus 200 is configured to confine a plurality of quantum objects such that the respective quantum states of the quantum objects may be manipulated, evolved in a controlled manner (e.g., in accordance with a quantum circuit), and/or the like.

For example, quantum objects may be used as the qubits of a quantum computer 110. For example, quantum operations (single qubit quantum logic gates, two-qubit quantum logic gates, initialization, reading/detecting operations, and/or the like) may be performed on quantum objects confined by the confinement apparatus 200 and/or system 100 comprising the confinement apparatus. For example, the confinement apparatus 200 is configured to maintain one or more quantum objects at respective locations and/or transport quantum objects between respective locations such that the quantum operation may be performed on the one or more quantum objects at various target locations defined at least in part by the confinement apparatus.

In various embodiments, the assembly 280 includes a confinement apparatus 200 and one or more optical concentrators. In various embodiments, one or more optical concentrators are formed on a first substrate hosting the potential generating elements (e.g., electrodes) of the confinement apparatus 200. In various embodiments, the assembly 280 also includes a second substrate 250 that is secured with respect to the first substrate and that hosts one or more optical concentrators.

In various embodiments, the system 100 comprising the confinement apparatus 200 comprises one or more manipulation sources 64 (e.g., 64A, 64B, 64C) configured to provide manipulation signals (e.g., laser beams and/or pulses, microwave signals/fields, and/or the like) such that the manipulation signals interact with one or more quantum objects confined at particular locations defined at least in part by the confinement apparatus. For example, the manipulation sources 64 may be configured to provide one or more manipulation signals in the form of optical signals that may be provided to at least a portion of the assembly 280 as low intensity optical signals.

In various embodiments, the system 100 comprises one or more magnetic field sources configured to provide a controlled magnetic field and/or magnetic field gradient at particular locations defined at least in part by the confinement apparatus for use in performing one or more quantum operations on one or more quantum objects confined by the confinement apparatus 200. In various embodiments, the system 100 comprises an optics collection system 80 configured to collect and/or detect light and/or photons emitted by one or more quantum objects disposed at the particular locations defined at least in part by the confinement apparatus.

In an example embodiment, the system 100 comprising the confinement apparatus 200 is and/or includes a quantum charge-coupled device (QCCD)-based quantum computer 110. For example, one or more of the quantum objects confined by the confinement apparatus 200 may be used as qubits of the quantum computer 110.

In various embodiments, the system 100 comprises a classical and/or semiconductor-based computing entity 10 and a quantum computer 110. In various embodiments, the quantum computer 110 comprises a controller 30 and a quantum processor 115. In various embodiments, the quantum processor 115 comprises a cryostat and/or vacuum chamber 40 enclosing an assembly 280 including the confinement apparatus 200, one or more manipulation sources 64 (e.g., 64A, 64B, 64C), one or more voltage sources 50, one or more magnetic field sources, an optics collection system 80, and/or the like. In various embodiments, the controller 30 is configured to control the operation of (e.g., control one or more drivers configured to cause operation of) the manipulation sources 64, beam path systems 66 (e.g., 66A, 66B, 66C) configured for providing manipulation signals to the confinement apparatus 200, voltage sources 50, magnetic field sources, a vacuum system and/or cryogenic cooling system (not shown), and/or the like. In various embodiments, the controller 30 is configured to receive signals (e.g., electrical signals) generated and provided by the optics collection system 80.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to generate manipulation signals (e.g., optical signals) configured to manipulate and/or cause a controlled quantum state evolution of one or more quantum objects confined by the confinement apparatus 200.

In an example embodiment, the one or more manipulation sources 64 each provide a manipulation signal (e.g., laser beam and/or the like) to one or more portions of the assembly 280 including the confinement apparatus 200 via corresponding beam path systems 66 (e.g., 66A, 66B, 66C). In various embodiments, at least one beam path system 66 comprises a modulator configured to modulate the manipulation signal being provided to the assembly 280 including the confinement apparatus 200 via the beam path system 66. In various embodiments, a beam path system 66 includes one or more photonic elements (e.g., waveguides, beam splitters, grating couplers, modulators, polarizers, etc.) integrated on the same substrate as the confinement apparatus and/or a photonic integrated circuit (PIC) disposed within the cryostat and/or vacuum chamber 40. In an example embodiment, a beam path system 66 includes one or more optical fibers configured to transport manipulation signals at least partially from a manipulation source 64 to a PIC formed on the same substrate as the confinement apparatus and/or another substrate configured to be secured with respect to the confinement apparatus (e.g., packaged with the substrate housing the confinement apparatus). In an example embodiment, one or more of the manipulation sources 64 are disposed within the cryostat and/or vacuum chamber 40 (e.g., on the same substrate as the confinement apparatus and/or another substrate configured to be secured with respect to the confinement apparatus). In various embodiments, the manipulation sources 64, modulator, and/or other components of the quantum computer 110 are controlled by the controller 30.

In various embodiments, a beam path system 66 includes projection optics configured to project an optical signal onto at least a portion of the assembly 280 including the confinement apparatus 200 as a low intensity optical signal. In some embodiments, the beam path system 66 may include multiple sets of projection optics and means for selecting and/or switching between which set of projection optics is used to provide a particular optical signal. In some embodiments, the beam path system 66 may be configured to provide the low intensity optical signal from within the first substrate (e.g., via an optical/photonics layer formed within the first substrate).

In various embodiments, the confinement apparatus 200 is an ion trap, such as a surface ion trap, Paul ion trap, and/or the like. In various embodiments, the quantum objects are ions; atoms; ion crystals and/or groups; atomic crystals and/or groups; charged, neutral, and/or multipolar molecules; quantum dots; quantum particles; groups, crystals, and/or combinations thereof (e.g., ion crystals); and/or the like. In various embodiments, the confinement apparatus 200 is an appropriate confinement apparatus for confining the quantum objects of the embodiment.

In various embodiments, the quantum computer 110 comprises one or more voltage sources 50. For example, the voltage sources may be arbitrary wave generators (AWG), digital to analog converters (DACs), and/or other voltage signal generators. For example, the voltage sources 50 may comprise a plurality of direct current voltage drivers and/or voltage sources and/or at least one radio frequency (RF) driver and/or voltage source. The voltage sources 50 may be electrically coupled to the corresponding potential generating elements and/or surface electrodes (e.g., control electrodes and/or RF electrodes) of the confinement apparatus 200, in an example embodiment.

In various embodiments, the quantum computer 110 comprises one or more magnetic field sources (not shown). For example, the magnetic field source may be an internal magnetic field source disposed within the cryogenic and/or vacuum chamber 40 and/or an external magnetic field source disposed outside of the cryogenic and/or vacuum chamber 40. In various embodiments, the magnetic field sources comprise permanent magnets, Helmholtz coils, electrical magnets, and/or the like. In various embodiments, the magnetic field sources are configured to generate a magnetic field and/or magnetic field gradient at one or more regions of the confinement apparatus 200 that has a particular magnitude and a particular magnetic field direction in the one or more regions of the confinement apparatus 200.

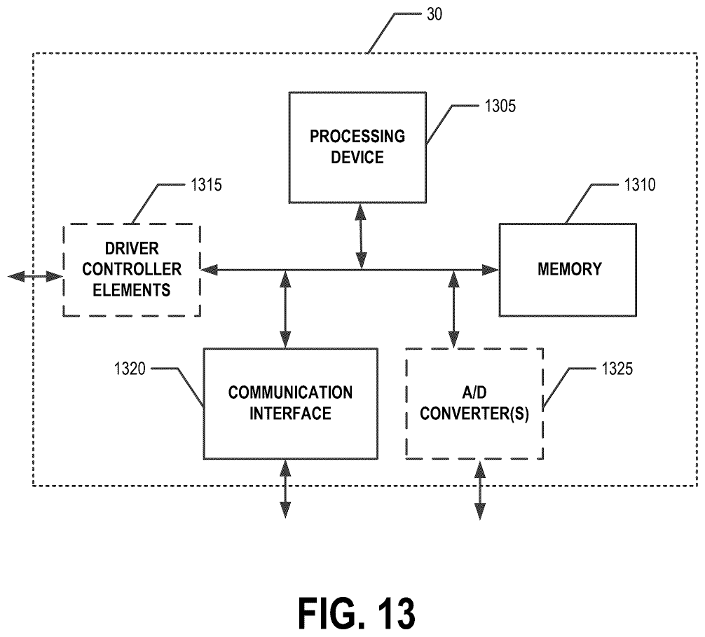

In various embodiments, the quantum computer 110 comprises an optics collection system 80 configured to collect and/or detect photons (e.g., stimulated emission) generated by atomic objects disposed in respective locations (e.g., during reading/detection operations) defined at least in part by the confinement apparatus. The optics collection system 80 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the atomic objects. While the optics collection system 80 is illustrated as being outside of the cryostat and/or vacuum chamber 40, in various embodiments, one or more optical elements and/or the one or more photodetectors of the optics collection system may be disposed within the cryostat and/or vacuum chamber 40. In various embodiments, the detectors may be in electronic communication with the controller 30 via one or more A/D converters 1325 (see FIG. 13) and/or the like.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control the voltage sources 50, magnetic field sources, cryogenic system and/or vacuum system controlling the temperature and/or pressure within the cryogenic and/or vacuum chamber 40, manipulation sources 64, beam path systems 66, and/or other systems controlling various environmental conditions (e.g., temperature, pressure, and/or the like) within the cryogenic and/or vacuum chamber 40, configured to manipulate and/or cause a controlled evolution of quantum states of one or more atomic objects within the confinement apparatus, and/or read and/or detect a quantum (e.g., qubit) state of one or more atomic objects within the confinement apparatus 200. For example, the controller 30 may cause a controlled evolution of quantum states of one or more atomic objects within the confinement apparatus to execute a quantum circuit and/or algorithm. For example, the controller 30 may read and/or detect quantum states of one or more atomic objects within the confinement apparatus at one or more points during the execution of a quantum circuit. In various embodiments, the atomic objects confined by the confinement apparatus are used as qubits of the quantum computer 110.

Example Assembly including a Confinement Apparatus

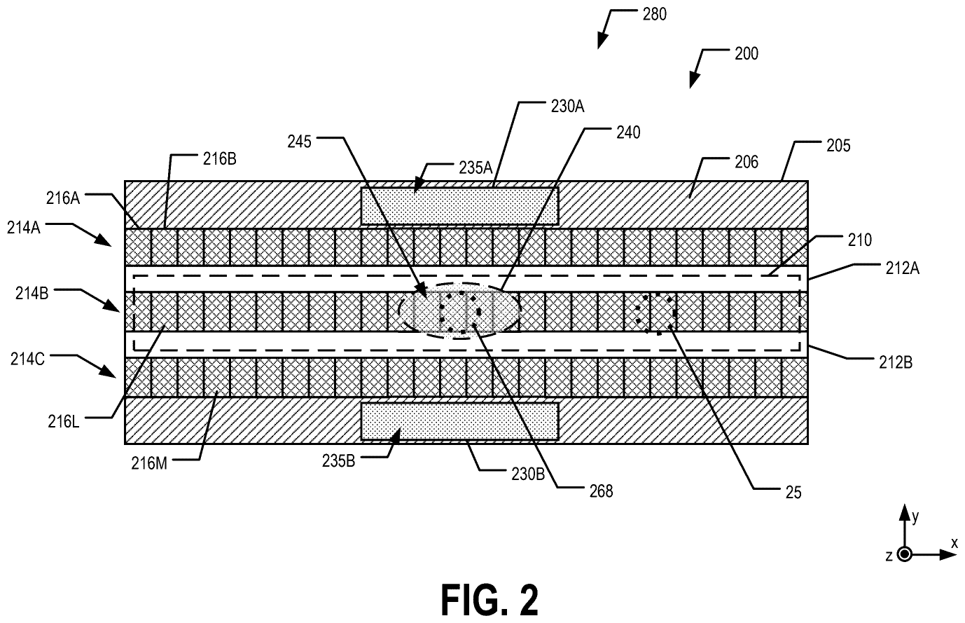

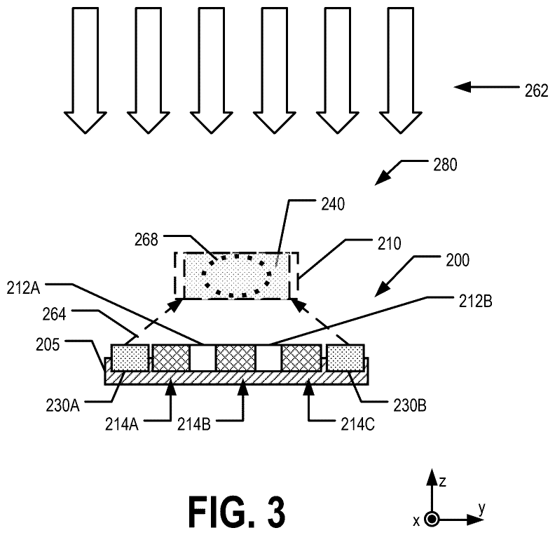

FIG. 2 provides a top view of at least a portion of an example assembly 280 including a confinement apparatus 200 that may be used to confine one or more quantum objects. FIG. 3 provides a cross-sectional view of the example assembly 280 including the confinement apparatus 200 illustrated in FIG. 2. For example, in the illustrated embodiment, the confinement apparatus is an ion trap (e.g., a surface ion trap) and the quantum objects are ions and/or ion crystals. The linear portion of the example confinement apparatus 200 may be part of a larger linear geometry of the confinement apparatus or may be part of a two-dimensional or three-dimensional geometry of the confinement apparatus, in various embodiments. In various embodiments, the assembly 280 includes the confinement apparatus 200 and one or more optical concentrators 230 (e.g., 230A, 230B).

In an example embodiment, the confinement apparatus 200 is at least partially defined by a number of RF electrodes 212 (e.g., 212A, 212B). While the RF electrodes 212 are illustrated as generally rectangular, in various embodiments, the RF electrodes 212 may have various geometries, as appropriate for the application. In various embodiments, the confinement apparatus 200 is at least partially defined by a number of sequences of control electrodes 214 (e.g., 214A, 214B, 214C). Each sequence of control electrodes 214 comprises a plurality of control electrodes 216 (e.g., 216A, 216B, . . . , 216L, 216M). While the control electrodes 216 are illustrated as generally rectangular, in various embodiments, the control electrodes 216 may have various geometries, as appropriate for the application.

In an example embodiment, each control electrode 216 and/or at least a non-empty subset of the control electrodes 216 may be operated independently via the application of control signals thereto. In an example embodiment, at least some of the control electrodes 216 are operated via application of a broadcast control signal. In an example embodiment, the confinement apparatus 200 is a surface Paul trap with symmetric RF electrodes 212. In various embodiments, the RF electrodes 212 and the control electrodes 216 generate potentials and/or fields that are experienced by quantum objects within respective confinement regions of the confinement apparatus 200. In particular, the RF electrodes 212 may be configured to define the respective confinement regions 210 of the confinement apparatus 200 and the control electrodes 216 may be configured to at least partially control movement and/or motion of quantum objects within the respective confinement regions 210.

The RF electrodes 212 and the control electrodes 216 are formed on and/or hosted by a first substrate 205. In the illustrated embodiment, the first substrate 205 also hosts optical concentrators 230A, 230B. In various embodiments, the optical concentrators comprise metasurfaces, diffractive optical elements (e.g., lenses, gratings, and/or the like), reflective optical elements (e.g., mirrors and/or other reflectors), and/or other signal manipulation elements configured to manipulate and/or control one or more optical properties of an optical signal incident thereon. In various embodiments, the optical concentrators are configured to have an optical signal incident thereon that is propagating with a non-zero component in either the positive z-direction or the negative z-direction, as illustrated in FIGS. 2 and 3. FIG. 3 illustrates an example of the optical signal 262 propagating with a non-zero component in the negative z-direction.

The optical concentrators 230A, 230B are configured to concentrate optical power incident thereon (e.g., as part of the optical signal 262) at a focal region 240. For example, a (low intensity) optical signal 262 is incident on the optical concentrators 230A, 230B. The optical concentrators concentrate the optical power incident thereon by causing respective concentrated optical signals 264 to focus at and/or project into the focal region 240. The focal region 240 has a non-zero spatial overlap with the confinement region 210. For example, a target location 268 defined at least in part by the confinement apparatus 200 is disposed within the non-zero spatial overlap of the confinement region 210 and the focal region 240. A quantum object located at the target location 268 will therefore experience a high intensity optical signal when the (low intensity) optical signal 262 is used to illuminate the illustrated portion of the assembly 280 including the confinement apparatus 200.

As used herein, the term “low intensity” optical signal refers to the intensity of the optical signal being too low to cause the corresponding quantum state evolution with a statistically significant error probability. The statistically significant error probability may be determined based on the application (e.g., a desired and/or required fidelity of the quantum state evolution and/or quantum computations being performed). In an example embodiment, the statistically significant error probability is 5%. In such an embodiment, a low intensity optical signal is an optical signal with an intensity low enough that there is a 5% or smaller probability of the low intensity optical signal causing the corresponding quantum state evolution.

As used herein, the term “high intensity” optical signal refers to the intensity of the optical signal being sufficiently high to cause the corresponding quantum state evolution with a statistically significant action probability. The statistically significant action probability may be determined based on the application (e.g., a desired and/or required fidelity of the quantum state evolution and/or quantum computations being performed). In an example embodiment, the statistically significant action probability is 95%. In such an embodiment, a high intensity optical signal is an optical signal with an intensity high enough that there is a 95% or higher probability of the high intensity optical signal causing the corresponding quantum state evolution.

For example, at a location 25 that is within the confinement region 210 but not within the focal region 240, the intensity of the optical signal incident thereon is low as the location 25 only receives the low intensity optical signal 262. The intensity of the optical signal incident on the target location 268 located in the non-zero spatial overlap of the focal region 240 and the confinement region 210 is high, as the concentrated optical signals 264 are incident on the target location 268.

In various embodiments, a first optical concentrator 230A has a first surface area 235A and a second optical concentrator 230B has a second surface area 235B. In an example embodiment, the first surface area 235A and the second surface area 235B are measured in a plane parallel to a surface 206 of the first substrate 205. The focal region 240 defines a focal region area 245 within the area of the focal region in a plane that is parallel to a surface 206 of the first substrate 205. The focal region area 245 is smaller than the surface areas 235A, 235B. For example, the sum of the surface areas 235 of one or more optical concentrators 230 that are configured to concentrate optical signals into a given focal region 240 is larger than the focal region area 245 of the given focal region 240 and a respective confinement region 210. For example, an optical concentrator formed as a circle having a diameter of 55 microns may be configured to concentrate optical signals into a focal region having a spatial overlap area that is circular and has a diameter of 1 micron. This results in a geometric concentration of 3,000 times the optical intensity being provided to the focal region by the optical concentrator compared to the optical intensity of the optical signal that was incident on the optical concentrator. While this is merely an example, it illustrates how a low intensity optical signal 262 may be concentrated into a high intensity optical signal at a focal region.

In various embodiments, the optical signal 262 is configured to flood illuminate at least a portion of the assembly 280 comprising the confinement apparatus 200 and the optical concentrator(s) 230 (housed on the first substrate 205 and/or the second substrate 250). The term flood illuminate is used herein to indicate that the optical signal 262 has a large cross-sectional area (e.g., in a plane parallel to the surface 206 of the substrate 205). For example, a diameter of the cross-section (in a plane that is parallel to the surface 206 of the substrate 205) of the optical signal 262 may be greater than 50 microns. For example, the diameter of a cross-section (in a plane that is parallel to the surface 206 of the substrate 205) of the optical signal 262 may be in a range of 20 microns to 10 centimeters.

In various embodiments, the optical concentrators 230 are configured to control one or more optical properties of the concentrated optical signal 264. For example, the optical concentrators 230 may be configured to control the direction of propagation, wavelength and/or frequency, polarization, optical mode/profile, relative phase delay, focus location, and/or other optical property of the concentrated optical signal 264. For example, the optical concentrators 230 may cause the concentrated optical signal 264 to be focused at the focal region 240. In another example, the optical concentrator may control how the concentrated optical signal is projected at the focal region 240. For example, the concentrated optical signal may be projected as a hologram, structured light, a higher order optical mode, and/or the like.

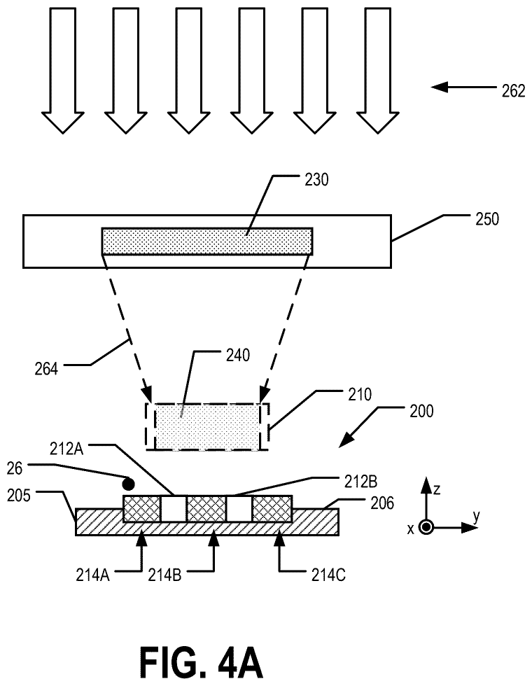

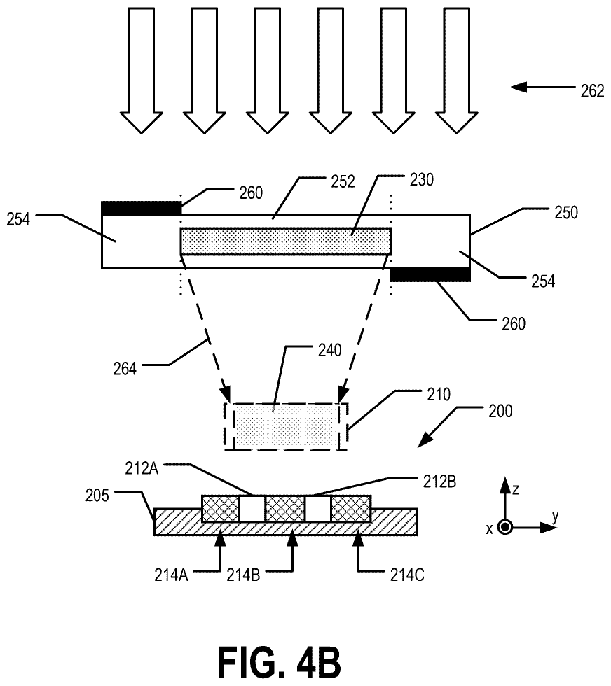

FIG. 4A illustrates an example assembly 280 that includes a first substrate 205 hosting the potential generating elements (e.g., RF electrodes 212 and the control electrodes 216) of the confinement apparatus 200 and a second substrate 250 hosting at least one optical concentrator 230. In an example embodiment, the second substrate 250 is formed of and/or comprises a material that is transparent to light in a selected range of wavelengths. For example, the second substrate 250 may be transparent to light in a wavelength range that includes a wavelength that characterizes the optical signal 262. In an example embodiment, the second substrate 250 comprises glass and/or the like.

The optical concentrator 230 is configured to, when an optical signal 262 is incident thereon, cause a concentrated optical signal 264 to be focused at a focal region 240 that has a non-zero spatial overlap with the confinement region 210. The optical concentrator 230 has a surface area (e.g., in a plane parallel to the surface 206 of the first substrate 205 or the xy plane as illustrated) that is larger than the surface area of the focal region 240 (as measured in a plane parallel to the surface 206 of the first substrate 205 or the xy plane as illustrated).

The optical concentrators 230 may define shadow regions in the vicinity of the focal regions. For example, location 26 is located within a shadow region, where the shadow region is an area of the confinement apparatus that is outside of the focal region of all of the concentrators but is protected from the optical signal 5 by the optical concentrator 230. In some embodiments, annular portions of the first substrate defined by the projection of a concentrator onto the confinement apparatus minus the respective focal region corresponding to the concentrator, is a shadow region. Less optical power is incident within the shadow region compared to an area just outside the shadow region (outside of the projection of the concentrator onto the confinement apparatus).

FIG. 4B illustrates another example assembly 280 that includes a first substrate 205 hosting the potential generating elements (e.g., RF electrodes 212 and the control electrodes 216) of the confinement apparatus 200 and a second substrate 250 hosting at least one optical concentrator 230. The second substrate 250 also includes one or more extinction elements 260 configured to absorb, reflect, or redirect portions of the optical signal 262 that are incident on the second substrate at locations that do not correspond to an optical concentrator 230. For example, a second substrate 250 includes a concentrator portion 252 corresponding to an optical concentrator 230. For example, most of the optical signal 262 that is incident on the concentrator portion 252 will interact with the corresponding optical concentrator 230 and be concentrated into the focal region 240. The second substrate 250 also includes at least one non-concentrator portion 254. Most of the optical signal 262 that is incident on the non-concentrator portion 254 will not interact with an optical concentrator and will not be concentrated into a focal region. In the embodiment illustrated in FIG. 4B, extinction elements 260 are disposed on surfaces of the non-concentrator portions 254 of the second substrate 250. In some embodiments, the extinction elements 260 may be disposed within the second substrate 250 rather than on a surface thereof.

In various embodiments, the extinction elements 260 are optical absorbers, diffractive optical elements, reflective optical elements, metasurfaces, and/or the like configured to absorb, reflect, and/or redirect portions of the optical signal 262 incident thereon. Thus, portions of the optical signal 262 that interact with the extinction elements 260 may not reach the confinement region 210. This results in the extinction between location 25 (located within the confinement region 210 but outside of the focal region 240 as shown in FIG. 2) and the target location 268 (located within both the confinement region 210 and the focal region 240) to be even larger (compared to when the extinction elements 260 are not present). In such an embodiment, the optical signal 262 may not be a low intensity optical signal.

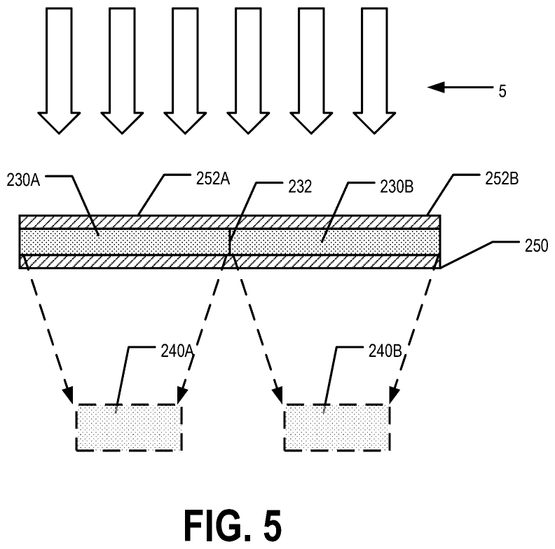

FIG. 5 illustrates another example second substrate 250 hosting optical concentrators 230A, 230B. The portion of the second substrate 250 illustrated in FIG. 5 includes a first concentrator portion 252A corresponding to the first optical concentrator 230A and a second concentrator portion 252B. For example, most of any portion of the optical signal 262 that is incident on the first concentrator portion 252A of the second substrate 250 will interact with the first optical concentrator 230A and be concentrated into the first focal region 240A. Most of any portion of the optical signal 262 that is incident on the second concentrator portion 252B of the second substrate 250 will interact with the second optical concentrator 230B and be concentrated into the second focal region 240B. The first optical concentrator 230A and the second optical concentrator 230B abut one another at a shared boundary 232. For example, the first optical concentrator 230A and the second optical concentrator 230B have a shared boundary 232. In various embodiments comprising a plurality of optical concentrators, adjacent optical concentrators may have a shared boundary so as to limit the portion of the second substrate that does not correspond to an optical concentrator.

The example second substrate 250 illustrated in FIG. 5 is configured to reduce the amount of optical power that reaches locations 25 (e.g., within a confinement region 210 but outside of a focal region 240) by reducing the amount of space between optical concentrators 230. For example, the space between the optical concentrators 230 may be minimized such that the optical concentrators share common boundaries 232. For example, the non-concentrator portions 254 of the second substrate 250 are minimized. For example, the second substrate 250 may be configured such that more than 70%, more than 75%, more than 80%, more than 85%, more than 90% or more than 95% of the area second substrate 250 (in a plane that is parallel to the surface 206 of the first substrate 205) that is aligned with the confinement apparatus along a direction of propagation of the optical signal 262 is within respective concentrator portions 252. In such an embodiment, the optical signal 262 may not be a low intensity optical signal.

In various embodiments, an optical concentrator 230 is configured to perform filtering of optical signals. For example, an assembly 280 may be configured to have various optical signals incident thereon. The optical signals may be filtered by the optical concentrators 230 based on wavelength and/or frequency, angle of incidence, polarization, optical mode, and/or another optical property of the optical signal 262 incident on the optical concentrator 230. The optical concentrator 230 performs filtering by causing a concentrated optical signal (represented by the dashed arrows) to be provided to a focal region 240 when an optical signal 262 having one or more target optical properties is incident on the optical concentrator 230 and not causing a concentrated optical signal 264 to be provided to the focal region 240 when the optical signal 262 incident on the optical concentrator 230 does not have the one or more target optical properties.

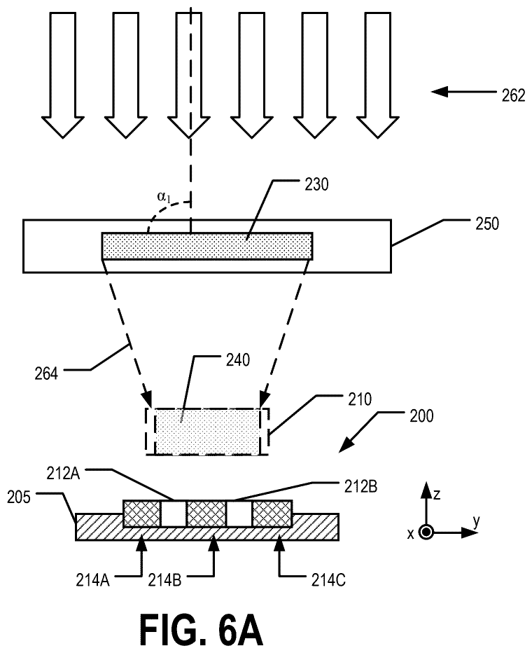

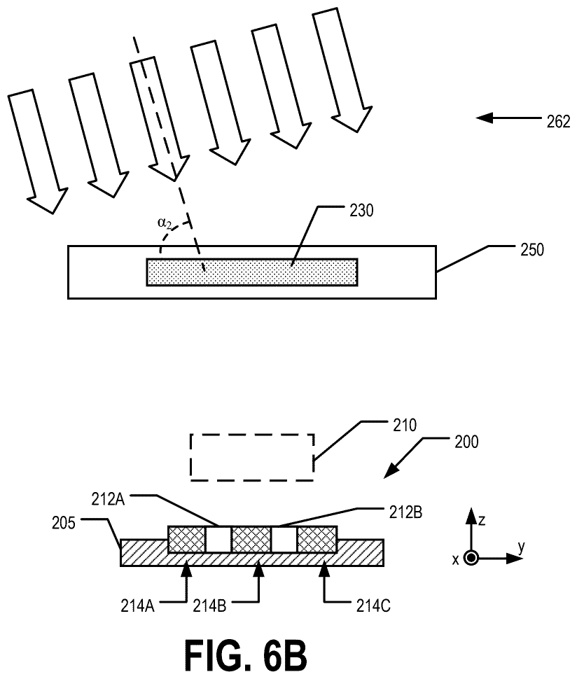

FIG. 6A illustrates an example portion of an assembly 280 including a confinement apparatus 200 hosted by a first substrate (e.g., the potential generating elements of the confinement apparatus 200 are hosted by the first substrate 205) and a second substrate 250. The second substrate 250 hosts an optical concentrator 230. The optical concentrator 230 in FIGS. 6A and 6B is configured to perform filtering based on the angle of incidence of the optical signal 262. In other words, the optical concentrator 230 in FIGS. 6A and 6B is configured to cause a concentrated optical signal 264 to be focused at the focal region 240 when the angle of incidence of an incoming optical signal 262 is within a target incidence angle range and to not cause a concentrated optical signal 264 to be focused at the focal region 240 when the angle of incident of an incoming optical signal 262 is not within the target incidence angle range.

For example, in FIG. 6A, the incoming optical signal 262 has an incidence angle of α₁, which is within the target incidence angle range. For example, in the example embodiment illustrated in FIGS. 6A and 6B, the target incidence range is 75 to 105 degrees and α₁ is 90 degrees. Thus, the optical concentrator 230 causes the concentrated optical signal 264 to be focused at the focal region 240. In FIG. 6B, the incoming optical signal 262 has an incidence angle of α₂, which is not within the target incidence angle range (e.g., the target incidence range is 75 to 105 degrees and α₂ is about 60 degrees, for example). Thus, the optical concentrator 230 does not cause a concentrated optical signal 264 to be focused at the focal region 240. The example target incident range provided herein is for illustration and the target incident range of various embodiments may be selected and/or configured as appropriate for the application.

In some embodiments, when the incoming optical signal 262 does not have the one or more target optical properties, the optical concentrator 230 generally does not interact with the incoming optical signal 262. For example, when the incoming optical signal 262 does not have the one or more target optical properties, the incoming optical signal 262 may pass through the optical concentrator 230 substantially unaffected. In some embodiments, when the incoming optical signal 262 does not have the one or more target optical properties, the optical concentrator 230 may deflect, refract, scatter, and/or redirect the optical signal 262 away from the focal region 240 and/or confinement region 210.

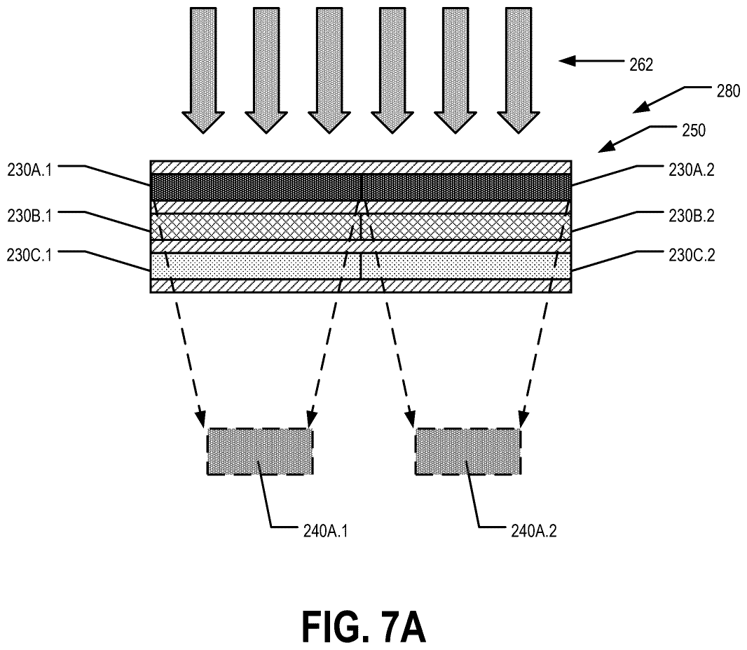

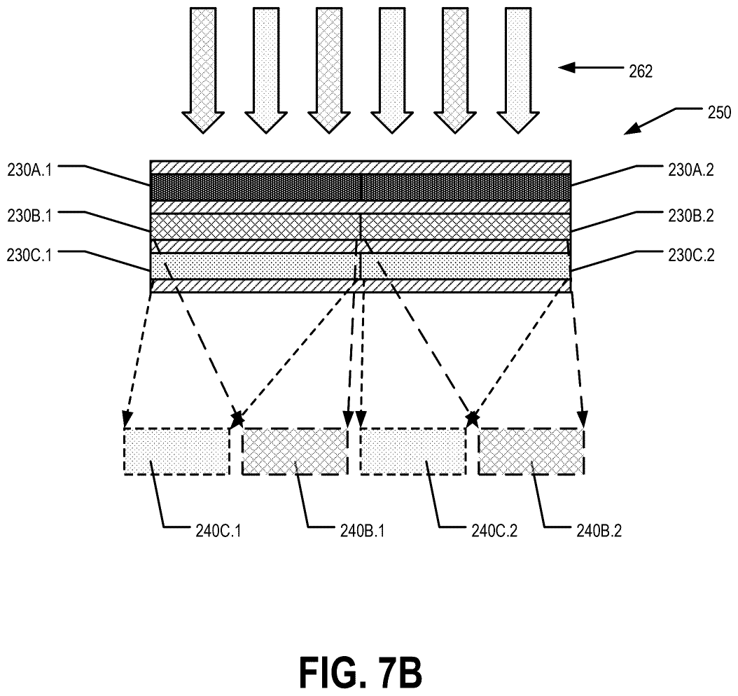

FIGS. 7A and 7B illustrate another example portion of an assembly 280 including a second substrate 250 that hosts a plurality of optical concentrators that are configured to filter optical signals incident thereon based on one or more optical properties of the incident optical signal. For example, the optical concentrators 230A.1, 230A.2 may be configured to concentrate optical signals characterized by a first wavelength or that are within a first wavelength range, optical concentrators 230B.1, 230B.2 may be configured to concentrate optical signals characterized by a second wavelength or that are within a second wavelength range, and optical concentrators 230C.1, 230C.2 may be configured to concentrate optical signals characterized by a third wavelength or that are within a third wavelength range.

As shown in FIGS. 7A and 7B, the optical concentrators may be provided in a stacked or layered configuration. For example, the second substrate 250 may host sequences of optical concentrators 230 that are stacked or layered with different optical concentrators within the sequence configured to act on optical signals having different optical characteristics and/or to affect/control different optical characteristics of optical signals concentrated thereby. For example, optical concentrators 230A.1, 230B.1, 230C.1 is a first sequence of stacked or layered optical concentrators and optical concentrators 230A.2, 230B.2, 230C.2 is a second sequence of stacked or layered optical concentrators.

FIG. 7A illustrates a scenario where an optical signal 262 characterized by a first wavelength is incident on at least a portion of the assembly 280, such as a surface of the second substrate 250. The optical signal 262 characterized by the first wavelength is concentrated by optical concentrators 230A.1, 230A.2 into focal regions 240A.1, 240A.2, respectively. The optical signal 262 characterized by the first wavelength is substantially not affected by the optical concentrators 230B.1, 230B.2, 230C.1, 230C.2 as the optical signal 262 characterized by the first wavelength does not have the target optical properties corresponding thereto.

FIG. 7B illustrates a scenario where an optical signal 262 that includes a portion that is characterized by a second wavelength and a portion that is characterized by a third wavelength is incident on at least a portion of the assembly, such as the second substrate 250. The portion of the optical signal 262 that is characterized by the second wavelength is concentrated by optical concentrators 230B.1, 230B.2 into focal regions 240B.1, 240B.2, respectively. The portion of the optical signal 262 that is characterized by the third wavelength is concentrated by optical concentrators 230C.1, 230C.2 into focal regions 240C.1, 240B.2. While the focal regions are illustrated in FIG. 7B as not overlapping, in some embodiments, various focal regions may overlap. For example, focal region 240C.1 spatially overlaps, at least in part, focal region 240B.2, in an example embodiment. Various concentrators and/or sequences of concentrators may be used in various embodiments (e.g., two concentrators, four or more concentrators, and/or the like) as appropriate for the application.

Thus, the optical concentrators may be configured to concentrate a portion of an optical signal that is characterized by target optical properties (e.g., a target angle of incidence or an angle of incidence within a target range of angles of incidence, a target wavelength or a wavelength within a target range of wavelengths, a target polarization, a target optical mode) at a respective focal region.

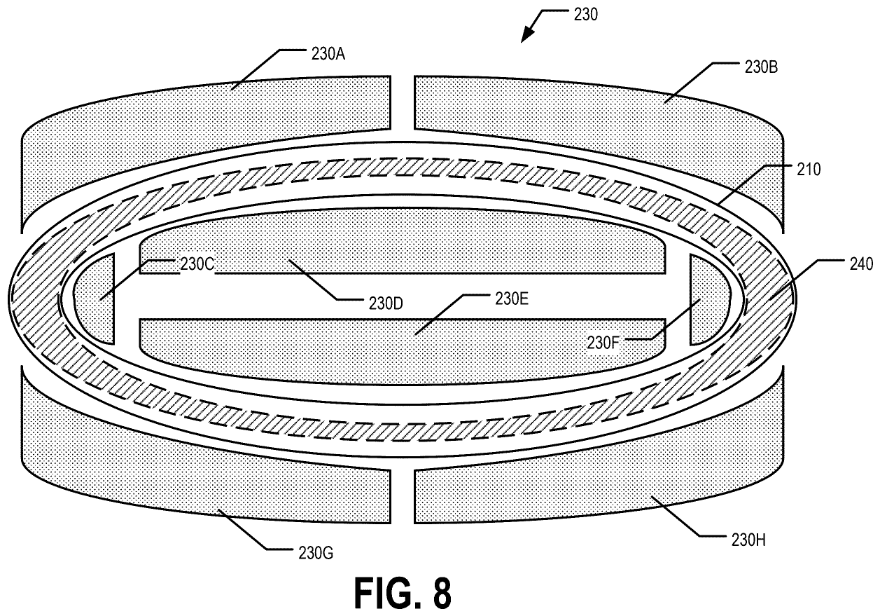

In various embodiments, a focal region 240 may be an extended focal region that extends along at least a portion of a confinement region. For example, the confinement apparatus 200 may be able to transport quantum objects along a one-dimensional, two-dimensional, or three-dimensional network of confinement regions. In some embodiments, a focal region 240 may extend along at least a portion of the network of confinement regions such that a quantum object may be addressed by a concentrated optical signal as the quantum object is transported through the network of confinement regions. For example, FIG. 8 illustrates an example confinement region 210 that is an oval. The optical concentrators 230A-H are configured to concentrate an optical signal incident thereon into an extended focal region 240 that extends along the confinement region 210. For example, an optical signal may be provided that is configured to perform laser cooling (e.g., Doppler cooling) on quantum objects as the quantum objects are transported along the confinement region 210. The optical concentrators configured to concentrate optical signals into the extended focal region 240 may include a plurality of segmented optical concentrators 230 or may include a single optical concentrator that extends along the confinement region 210. In another example where the network of confinement regions comprises an array of one-dimensional confinement regions, the extended focal region 240 may extend along a length of one of the one-dimensional confinement regions. The focal region may have various geometries as appropriate for the geometry of the confinement region of various embodiments.

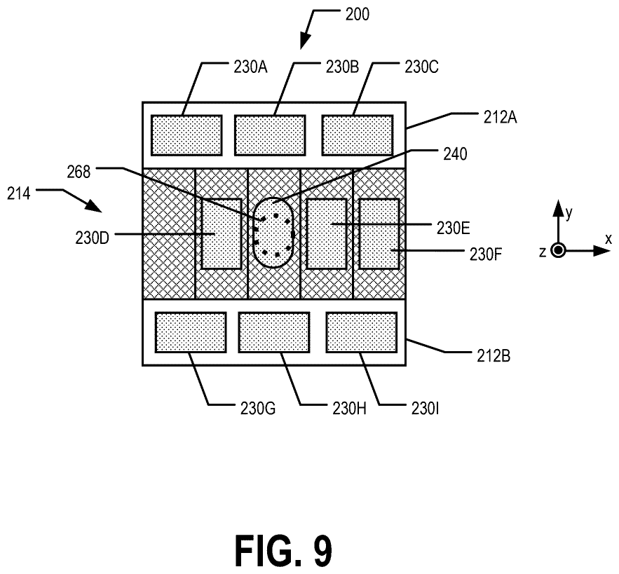

FIG. 9 illustrates an example portion of an assembly 280 including a confinement apparatus 200 and optical concentrators 230A-230I, where each of the optical concentrators 230A-I is configured to concentrate light into a focal region 240. For example, the focal region 240 may overlap with a target location 268. The optical concentrators 230A-I are configured to filter optical signals incident thereon. When the optical signal incident on the optical concentrator has optical properties that match the target optical properties of the optical concentrator, the optical concentrator causes the optical signal to be concentrated onto the focal region 240.

For example, each optical concentrator 230A-I may be configured for performing a corresponding function of the system. For example, optical concentrators 230A, 230C may be configured for performing a two-qubit gate at the target location 268. Optical concentrators 230G, 230H may be configured for performing a single qubit gate at the target location 268. Optical concentrator 230I may be configured for performing a qubit reading operation. Optical concentrators 230D, 230E, 230F may be configured for use in laser cooling operations, qubit initialization operations, and/or optical repumping. As should be understood, the provided examples are illustrative and a variety of configurations of optical concentrators may be employed, as appropriate for the application.

In various embodiments, the optical concentrators may control one or more optical properties (direction of propagation, wavelength and/or frequency, polarization, optical mode/profile, relative phase delay, focus location, and/or other optical property) of the concentrated optical signal provided to the focal region. For example, the optical concentrators may control one or more optical properties of the concentrated optical signal such that the concentrated optical signal is configured to perform the corresponding operation.

### Example Beam Path System and Example Operation Thereof

In various embodiments, the system includes a beam path system 66 configured to illuminate at least a portion of the assembly 280 including the confinement apparatus 200 and one or more optical concentrators 230 (e.g., either on the first substrate that hosts the potential generating elements of the confinement apparatus or on a second substrate that is secured with respect to the first substrate). In various embodiments, the beam path system may include free space optical elements (lenses, mirrors, and/or the like) and/or guided mode optical elements (waveguides, optical fibers, gratings, and/or the like) that define beam paths from a manipulation source to the assembly 280.

In various embodiments, the beam path system includes projection optics configured to project an optical signal onto at least a portion of the assembly 280. For example, a set of projection optics may comprise one or more lenses, gratings, metasurfaces, and/or the like configured to cause the optical signal to be projected onto at least a portion of the assembly 280 with a respective projection pattern.

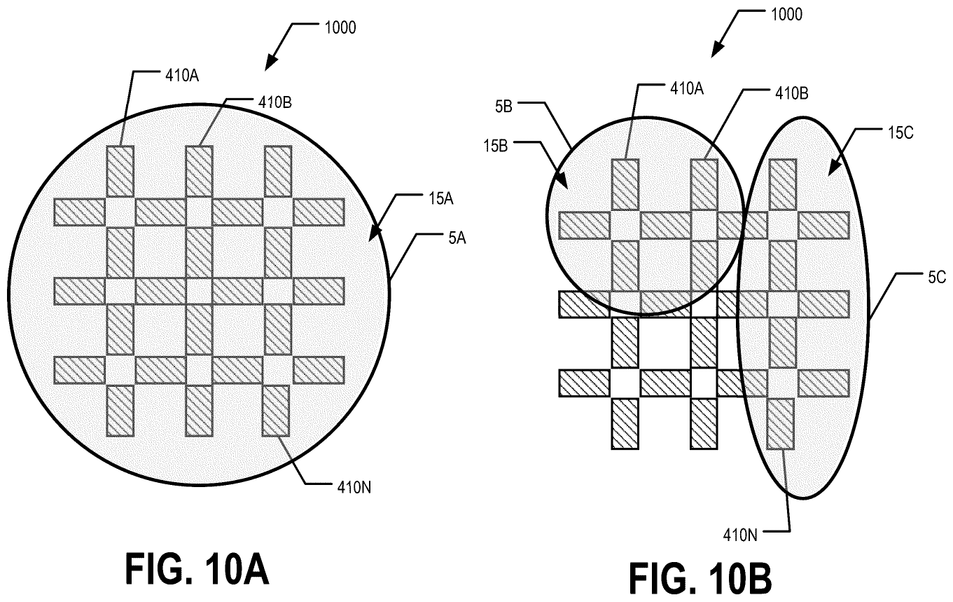

In various embodiments, the projection optics control what portion of the assembly 280 is illuminated with the optical signal. For example, the projection optics may control onto which portion(s) of the assembly the optical signal is projected. For example, FIGS. 10A and 10B illustrate an example network 1000 of confinement regions 410A-N and three example projection patterns of an optical signal onto the network 1000 of confinement regions 410. For example, the first projection pattern 15A illuminates the entire network 1000 of confinement regions. The second projection pattern 15B illuminates a corner of the network 1000 of confinement regions and the third projection pattern 15C illuminates a strip of the network 1000 of confinement regions. The illustrated projection patterns 15A-C are provided as illustrative examples. Various other projection patterns may be used in various embodiments as appropriate for the application.

In various embodiments, the projection optics may control a structure of the optical signal 262. For example, spatial light modulation (SLM) or mode engineering of the optical signal 262 may be used to select which portions of the assembly 280 are illuminated by the optical signal 262. For example, the Talbot self-imaging effect could be used to cause some areas of the assembly 280 to be illuminated and other areas to not be illuminated by the optical signal 262. In another example, the flood beam may be provided as a hologram that illuminates some areas of the assembly 280 and not others.

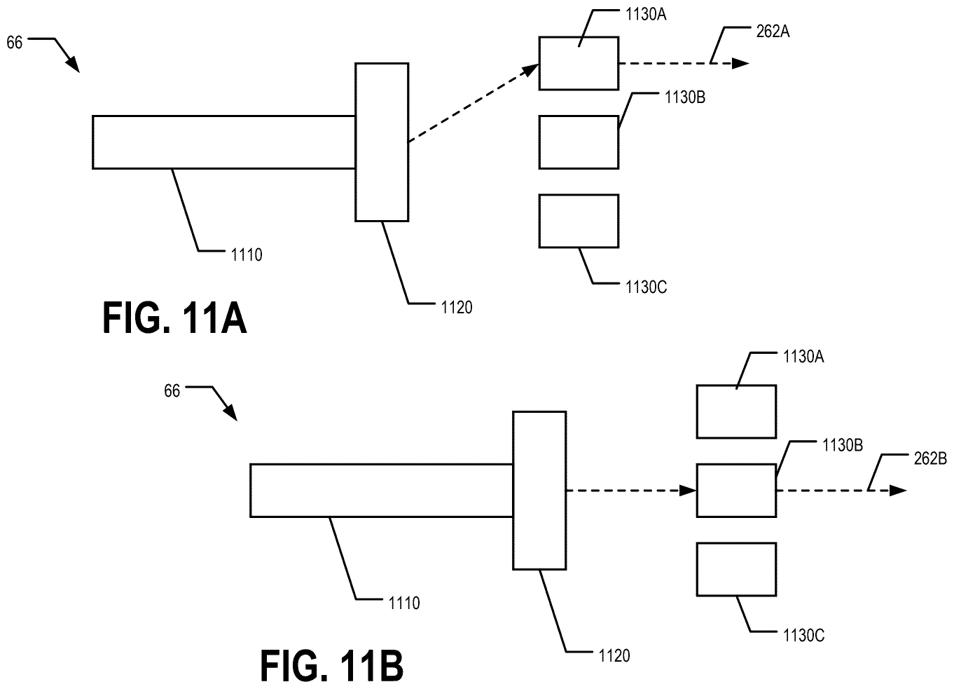

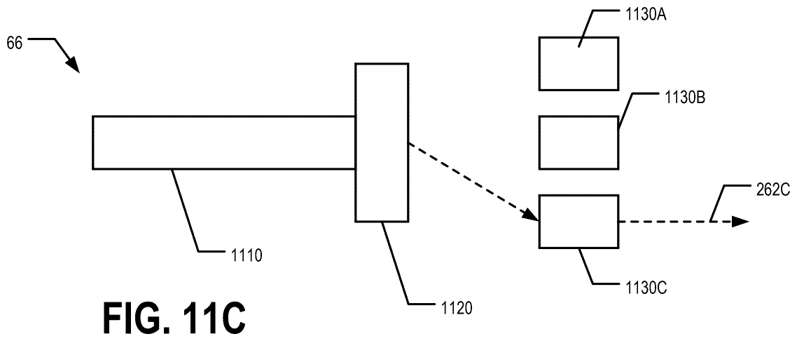

In various embodiments, a beam path system may include selectable projection optics. For example, the beam path system may include multiple sets of projection optics and a particular set of projection optics may be selected for providing a particular optical signal. For example, FIGS. 11A-11C illustrate a portion of a beam path system 66 including multiple selectable sets of projection optics 1130A, 1130B, 1130C. The illustrated portion of the example beam path system 66 includes an optical fiber 1110, a switchable component 1120, and the multiple selectable sets of projection optics 1130A-C. In an example embodiment, the switchable component 1120 is an electro-optical deflector (EOD). Various other beam path systems 66 may include waveguides, free space optic elements, a photonic integrated circuit (PIC), and/or the like instead of and/or in addition to the optical fiber 1110.

The optical fiber 1110 provides the optical signal (e.g., generated by a manipulation source 64) to the switchable component 1120. When the switchable component 1120 is operated in a first operating mode, the switchable component 1120 is configured to provide the optical signal to a first set of projection optics 1130A. The first set of projection optics 1130A projects the optical signal onto at least a portion of the assembly 280. For example, the first set of projection optics 1130A may be configured to project the optical signal onto the assembly 280 with the first projection pattern 15A. When the switchable component 1120 is operated in a second operating mode, the switchable component 1120 is configured to provide the optical signal to the second set of projection optics 1130B. The second set of projection optics 1130B projects the optical signal onto at least a portion of the assembly, such as a second projection pattern 15B, for example. When the switchable component 1120 is operated in a third operating mode, the switchable component 1120 is configured to provide the optical signal to the third set of projection optics 1130C. The third set of projection optics 1130C projects the optical signal onto at least a portion of the assembly, such as a third projection pattern 15C, for example.

Various embodiments may include various numbers of sets of projection optics and the switchable component may be operable in various numbers of operating modes. In various embodiments, the switchable component 1120 is in electrical communication with the controller 30 and the controller 30 is configured to control in which operating mode the switchable component 1120 is operated.

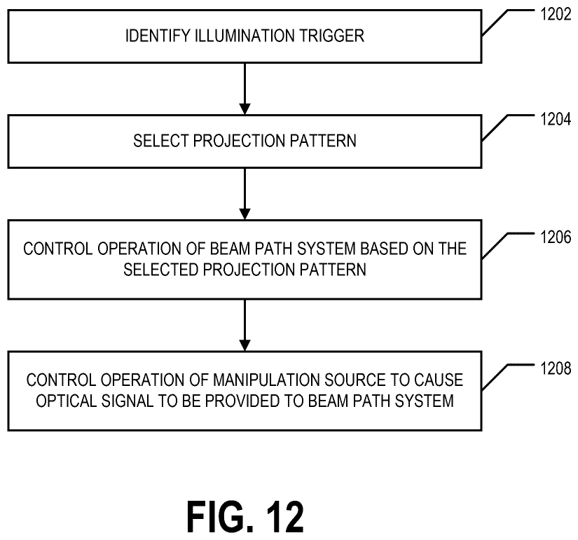

FIG. 12 provides a flowchart illustrating various processes, procedures, operations, and/or the like performed by the controller 30 to cause an optical signal to be provided the assembly 280 with a selected projection pattern. Starting at step 1202, the controller 30 identifies an illumination trigger. For example, the controller 30 may comprise means, such as processing device 1305, memory 1310, and/or the like (see FIG. 13), for identifying an illumination trigger. For example, the controller 30 may execute a queue of commands and/or executable instructions and the queue may include a command or executable instruction indicating that an optical signal is to be provided to at least a portion of the assembly 280. In an example embodiment, the command or executable instruction may indicate which portion(s) of the assembly 280 and/or which target locations 268 should be illuminated.

At step 1204, the controller 30 selects a projection pattern. For example, the controller 30 comprises means, such as processing device 1305, memory 1310, and/or the like, for selecting a projection pattern. For example, the beam path system 66 comprises multiple sets of projection optics with each set of projection optics configured to project a respective projection pattern. The controller 30 may store (e.g., in memory 1310) representations of each of the projection patterns. Based at least in part on the illumination trigger (e.g., which portion(s) of the assembly 280 and/or which target locations 268 of the confinement apparatus 200 should be illuminated) and the stored representations of the projection patterns, the controller 30 selects one of the projection patterns. For example, the controller 30 may select a projection pattern that illuminates each of the portions of the assembly 280 and/or target locations 268 that should be illuminated.

At step 1206, the controller 30 controls operation of the switchable component 1120 to cause the set of projection optics corresponding to the selected projection pattern to be selected. For example, when a set of projection optics is selected, when an optical signal is provided to the switchable component 1120, the switchable component 1120 provides the optical signal to the selected set of projection optics. For example, the controller 30 comprises means, such as processing device 1305, memory 1310, driver controller elements 1315, and/or the like, for controlling operation of the switchable component 1120.

At step 1208, the controller 30 controls operation of a manipulation source 64 to cause the manipulation source 64 to generate the optical signal and provide the optical signal to the beam path system 66. For example, the controller 30 comprises means, such as processing device 1305, memory 1310, driver controller elements 1315, and/or the like, for controlling operation of the manipulation source 64. When the optical signal is generated by the manipulation source 64 and provided to the beam path system 66, the optical signal is provided to the selected set of projection optics 1130 via the switchable component 1120. The selected set of projection optics 1130 project the optical signal onto the assembly 280 in the selected projection pattern. The optical concentrators of the assembly 280 provide corresponding concentrated optical signals to the respective focal regions as a result of the optical signal being incident on the optical concentrators. The concentrated optical signal then causes respective functions of the system to be performed.

### Technical Advantages

Conventional techniques for providing laser beams to ions, for example, trapped by an ion trap, include focusing pencil beams on select ion locations. For example, when the system includes multiple ions, it is important to be able to control which ions are and which ions are not illuminated by various laser beams. The pencil beams have a small cross-sectional area such that each laser beam only illuminates a small portion of the system. However, minor misalignment of the pencil beams with the ion locations may result in the optical power delivered to a target ion being insufficient for the desired quantum state evolution to be performed, the target ion being missed by the laser beam, and/or other ions being unintentionally affected by the laser beam. As the cross-sectional area of the pencil beams is quite small, aligning the pencil beams and maintaining alignment throughout the performance of an experiment and/or a quantum circuit can be challenging. Thus, technical problems exist regarding how to efficiently and robustly provide optical signals to select locations of a confinement apparatus while not causing cross-talk errors by causing unintended interactions at other locations of the confinement apparatus.

Various embodiments provide technical solutions to these technical problems. For example, in various embodiments, at least a portion of an assembly including the confinement apparatus is illuminated with a low intensity optical signal. One or more optical concentrators of the assembly concentrate optical power incident thereon to cause a high intensity optical signal to be provided to a focal region. The focal region overlaps with a confinement region such that quantum objects confined within the spatial overlap of the confinement region and the focal region experience the high intensity optical signal and therefore experience the corresponding quantum state evolution. In various embodiments, the low intensity optical signal has an intensity (e.g., optical power per area) that is too low to perform a corresponding quantum state evolution. For example, when at least a portion of the assembly is illuminated with a low intensity optical signal, the extinction between a focal region and a portion of the confinement apparatus that is outside of the focal region may be −30 dB or more. In some embodiments, the optical concentrators are configured and/or extinction elements are included in the assembly such that the extinction between focal regions and areas of the confinement region outside of focal regions is more than −30 dB. Thus, quantum objects located outside of the focal region may generally not be affected by the low intensity optical signal.

As the optical concentrators are formed on a first substrate hosting the potential generating elements of the confinement apparatus and/or on a second substrate that is secured with respect to the first substrate, the alignment of the optical concentrators and the corresponding focal regions to the confinement region(s) is stable and independent of the projection optics configured to provide the low intensity optical signal. The system is therefore not sensitive to small changes in alignment of the projection optics providing the low intensity optical signal to the assembly.

Therefore, various embodiments provide technical improvements to the fields of beam delivery to trapped particles, atomic and/or quantum systems that use optical signals to interact with trapped particles, and quantum computing.

### Example Controller

Various embodiments provide systems comprising assemblies that include confinement apparatuses 200 and one or more optical concentrator. For example, various atomic systems, quantum systems, and/or the like may use a confinement apparatus 200 to confine one or more quantum objects and may use one or more optical concentrators 230 to concentrate light into a focal region that overlaps with a confinement region of the confinement apparatus 200 so as to interact with the quantum objects. In an example embodiment, the system is a quantum charge-coupled device (QCCD-based) quantum computer 110 or other quantum computer. In various embodiments, the system (e.g., quantum computer 110) includes a controller 30 configured to control various elements of the system. For example, the controller 30 may be configured to control the voltage sources 50, a cryogenic system and/or vacuum system for controlling the temperature and pressure within the cryogenic and/or vacuum chamber 40, manipulation sources 64 (e.g., 64A, 64B, 64C), beam path systems 66, magnetic field sources, and/or other systems controlling the environmental conditions (e.g., temperature, humidity, pressure, magnetic field gradient, and/or the like) within the cryogenic and/or vacuum chamber 40, configured to manipulate and/or cause a controlled evolution of quantum states of one or more atomic objects confined by the confinement apparatus, and/or read and/or detect a quantum state of one or more atomic objects confined by the confinement apparatus.

As shown in FIG. 13, in various embodiments, the controller 30 may comprise various controller elements including one or more processing devices 1305, memory 1310, driver controller elements 1315, a communication interface 1320, analog-digital converter elements 1325, and/or the like. For example, the one or more processing devices 1305 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products. In an example embodiment, the one or more processing devices 1305 of the controller 30 comprises a clock and/or is in communication with a clock. In various embodiments, this clock defines the clock cycles of the system.

For example, the memory 1310 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 1310 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 1310 (e.g., by a processing device 1305) causes the controller 30 to perform one or more steps, operations, processes, procedures and/or the like described herein for controlling one or more components of the quantum computer 110 (e.g., voltages sources 50, manipulation sources 64, magnetic field sources, and/or the like) to cause a controlled evolution of quantum states of one or more atomic objects, detect and/or read the quantum state of one or more atomic objects, and/or the like.

In various embodiments, the driver controller elements 1315 may include one or more drivers and/or controller elements each configured to control one or more drivers. In various embodiments, the driver controller elements 1315 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 1305). In various embodiments, the driver controller elements 1315 may enable the controller 30 to operate a manipulation source 64. In various embodiments, the drivers may be laser drivers; vacuum component drivers; drivers for controlling the flow of current and/or voltage applied to the electrodes (e.g., the RF, control, and/or other electrodes of the confinement apparatus 200) used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the electrodes (e.g., control electrodes 216 and/or RF electrodes 212).

In various embodiments, the controller 30 comprises means for communicating and/or receiving signals from one or more detectors such as optical receiver components (e.g., cameras, MEMs cameras, CCD cameras, photodiodes, photomultiplier tubes, and/or the like) of the optics collection system 80. For example, the controller 30 may comprise one or more analog-digital converter elements 1325 configured to receive signals from one or more detectors, optical receiver components, calibration sensors, and/or the like.

In various embodiments, the controller 30 may comprise a communication interface 1320 for interfacing and/or communicating with one or more computing entities 10. For example, the controller 30 may comprise a communication interface 1320 for receiving executable instructions, command sets, and/or the like from the computing entity 10 and providing output received from the quantum processor 115 (e.g., via the optics collection system 80) and/or the result of a processing the output (received from the quantum processor 115) to the computing entity 10. In various embodiments, the computing entity 10 and the controller 30 may communicate via a direct wired and/or wireless connection and/or one or more wired and/or wireless networks 20.

### Example Computing Entity

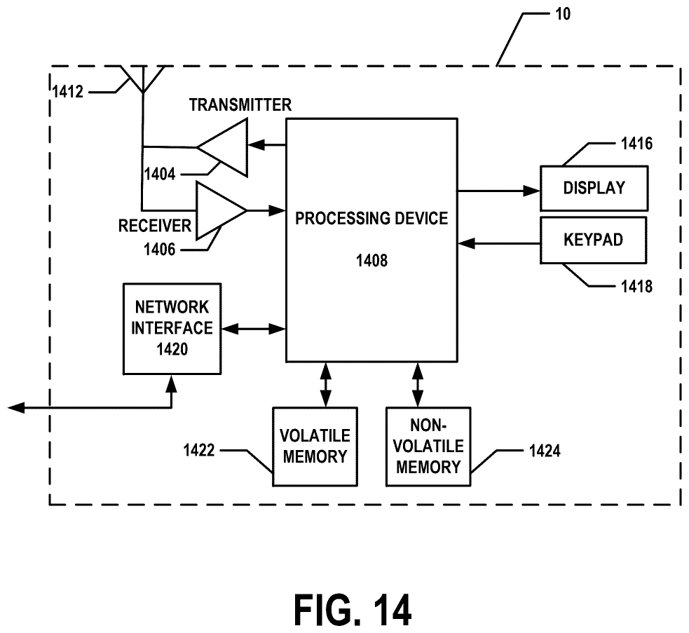

FIG. 14 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 14, a computing entity 10 can include an antenna 1412, a transmitter 1404 (e.g., radio), a receiver 1406 (e.g., radio), and a processing device 1408 that provides signals to and receives signals from the transmitter 1404 and receiver 1406, respectively.

The signals provided to and received from the transmitter 1404 and the receiver 1406, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 further comprises one or more network interfaces 1420 configured to communicate via one or more wired and/or wireless networks 20.

The computing entity 10 may also comprise a user interface device comprising one or more user input/output interfaces (e.g., a display 1416 and/or speaker/speaker driver coupled to a processing device 1408 and a touch screen, keyboard, mouse, and/or microphone coupled to a processing device 1408). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 1418 (hard or soft), a touch display, voice/speech or motion interfaces, scanners, readers, or other input device. In embodiments including a keypad 1418, the keypad 1418 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 1422 and/or non-volatile storage or memory 1424, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system comprising:
a confinement apparatus configured to confine a plurality of quantum objects within one or more confinement regions; and
one or more optical concentrators, wherein each optical concentrator of the one or more optical concentrators is configured to concentrate optical power incident thereon into a respective focal region, the respective focal region having a non-zero spatial overlap area with at least one of the one or more confinement regions, and the respective focal region having an area that is smaller than a surface area of the optical concentrator.

2. The system of claim 1, wherein the confinement apparatus is formed on a first substrate and at least one of:
at least one of the one or more optical concentrators is disposed on the first substrate, or
the system further comprises a second substrate that is secured with respect to the first substrate and at least one of the one or more optical concentrators is disposed on the second substrate.

3. The system of claim 1, wherein at least one of the one or more optical concentrators is configured to filter optical power incident thereon based on at least one optical property of an optical signal carrying the optical power such that:
responsive to the optical signal being characterized by a target optical property, the optical power provided by the optical signal is concentrated to the respective focal region, and
responsive to the optical signal not being characterized by the target optical property, the optical power provided by the optical signal is not concentrated to the respective focal region.

4. The system of claim 3, wherein the target optical property is a wavelength, a wavelength range, an angle of incidence, an angle of incidence range, a polarization, an optical mode, or a combination of two or more thereof.

5. The system of claim 3, wherein the at least one of the one or more optical concentrators is configured to have multiple optical signals incident thereon, and to perform filtering of the multiple optical signals based on the least one optical property of respective optical signals of the multiple optical signals.

6. The system of claim 3, wherein the confinement apparatus is formed on a first substrate, the system further comprises a second substrate that is secured with respect to the first substrate, the at least one of the one or more optical concentrators that is configured to filter optical power incident thereon based on the at least one optical property of the optical signal carrying the optical power comprises two or more optical concentrators that are disposed on the second substrate in a layered fashion.

7. The system of claim 1, wherein the one or more optical concentrators are each configured to control at least one optical property of the concentrated optical power at the respective focal region.

8. The system of claim 7, wherein the one or more optical concentrators are each configured to control the at least one optical property of the concentrated optical power at the respective focal region such that the at least one optical property of the concentrated optical power is different from a corresponding optical property of the optical power incident on the optical concentrator.

9. The system of claim 8, wherein the at least one optical property of the concentrated optical power is configured to cause the concentrated optical power to interact more strongly with one or more quantum and/or atomic objects disposed at the respective focal region compared to the corresponding optical property of the optical power incident on the optical concentrator.

10. (canceled)

11. The system of claim 1, wherein the concentrated optical power at the respective focal region is configured to control evolution of a quantum state of one or more quantum objects disposed at the focal region.

12. The system of claim 11, wherein the evolution of the quantum state of the one or more quantum objects disposed at the focal region includes performance of one or more of a single qubit gate, a two-qubit gate, a cooling operation, a repumping operation, a shelving operation, a state preparation operation, or a reading operation.

13. The system of claim 1, wherein the confinement apparatus is formed on a first substrate and the system further comprises a second substrate that is secured with respect to the first substrate and at least one of the one or more optical concentrators is disposed on the second substrate, wherein one or more extinction elements are disposed on the second substrate and the one or more extinction elements are configured to reduce an amount of optical power provided to the one or more confinement regions via portions of the second substrate that are not associated with the one or more optical concentrators.

14. The system of claim 1, wherein the confinement apparatus is formed on a first substrate and the system further comprises a second substrate that is secured with respect to the first substrate, the one or more optical concentrators comprising a plurality of optical concentrators disposed on the second substrate, and adjacent optical concentrators of the plurality of optical concentrators are configured to have shared boundaries therebetween.

15. The system of claim 1, further comprising an optical path system configured to cause an optical signal to be incident on at least a portion of a selected at least one of the one or more optical concentrators.

16. The system of claim 15, wherein the optical path system comprises a switchable component and two or more sets of projection optics, operation of the switchable component causes an optical signal to be provided to a selected set of projection optics of the two or more sets of projection optics, and the selected set of projection optics are configured to project the optical signal with a projection pattern that illuminates the selected at least one of the one or more optical connectors.

17. (canceled)

18. The system of claim 15, wherein the optical path system is configured to use at least one of spatial light modulation, beam forming, higher-order optical modes, holograms, or time-multiplexing to cause the optical signal to be incident on the selected at least one of the one or more optical concentrators.

19. The system of claim 15, wherein spatial light modulation is used to adjust an intensity distribution of the optical signal in a way that optimizes operation of a desired optical/ion interaction across all target regions being illuminated.

20. The system of claim 1, wherein the optical power concentrated is concentrated by a factor of at least 1000 compared to the optical power incident on the optical concentrator.

21. The system of claim 1, wherein the confinement apparatus is formed on a first substrate, the system further comprises a second substrate that is secured with respect to the first substrate, a first concentrator of the one or more optical concentrators is disposed on the second substrate, an annular portion of the first substrate defined by the projection of the first concentrator minus the respective focal region corresponding to the first concentrator is a shadow region and less optical power is incident thereon compared to an area just outside the shadow region.

22. A system comprising:
a confinement apparatus configured to confine a plurality of quantum objects in one or more confinement regions; and
a beam path system comprising a switchable component and two or more sets of projection optics,
wherein each of the two or more sets of projection optics are configured to, when an optical signal is incident thereon, illuminate a respective portion of the confinement apparatus, and
wherein operation of the switchable component is configured to select on which of the two or more sets of projection optics the optical signal is incident.

23-27. (canceled)
